(19) United States
(12) Patent Application Publication
(10) Pub. No.: US 2026/0155651 A1
(43) Pub. Date: Jun. 4, 2026

(54) Lightning-Resistant Power Transmission System

(71) Applicants: Xinyi Zhu, Shenzhen (CN); Faguo Zhu, Shenzhen (CN)

(72) Inventors: Xinyi Zhu, Shenzhen (CN); Faguo Zhu, Shenzhen (CN)

(21) Appl. No.: 19/036,982

(22) Filed: Jan. 24, 2025

(30) Foreign Application Priority Data
Nov. 29, 2024 (CN) 202422930745X
Nov. 29, 2024 (CN) 2024117348896

(51) Int. Cl. H02J 3/00; H02J 3/04; H02J 50/00; H02M 1/00; H02M 5/458

(52) U.S. Cl. CPC H02J 3/00125; H02J 3/04; H02J 50/001; H02M 1/008; H02M 5/458

(57) ABSTRACT

A system includes a first converter coupled to a first ac source, wherein the first converter is configured to convert a first ac voltage of the first ac source into a first ac current, a transmission line loop connected between two output terminals of the first converter, wherein the first ac current is configured to flow through the transmission line loop, and a second converter coupled to the transmission line loop, wherein the second converter is configured to convert the first ac current into a voltage fed into a load coupled to the second converter.

### RELATED APPLICATION

This application claims the benefit of and priority to Chinese Patent Application No. 202422930745X, filed on Nov. 29, 2024, and Chinese Patent Application No. 2024117348896, filed on Nov. 29, 2024, each of which is hereby incorporated by reference in its entirety.

### TECHNICAL FIELD

The present disclosure relates generally to the field of power transmission systems, and in particular embodiments, to a lightning-resistant power transmission system.

### BACKGROUND

With the continuous development of modern economies, the reliability of power transmission systems has become increasingly critical to electricity users. Currently, low-voltage power supply systems, such as 220V systems, are widely employed in residential, commercial, and industrial settings. These systems utilize transmission lines to deliver electrical power from generation networks to end-users. However, these low-voltage systems face significant challenges when exposed to environmental hazards, particularly lightning strikes.

Lightning strikes on outdoor transmission lines or electrical equipment generate high-magnitude lightning currents that result in substantial overvoltage conditions. These overvoltage events can propagate through the power transmission system in common-mode or differential-mode forms, often entering end-user electrical devices. The resulting overvoltage can exceed the voltage tolerance of the devices, leading to equipment malfunction or permanent damage.

Various protection devices such as lightning rods and lightning wires can only provide a certain level of protection for high-voltage transmission lines, towers, or large regional structures, reducing the probability of lightning strikes within the protected area. However, these protection devices cannot completely eliminate lightning strikes and prevent lightning strikes on conductors outside the protected area from being transmitted into the protected zone.

To mitigate lightning-induced damages, conventional low-voltage systems incorporate protective devices such as lightning arresters. These arresters are designed to reduce the amplitude of overvoltage by diverting lightning currents to the ground during lightning strikes. While effective in decreasing overvoltage magnitude, lightning arresters do not fully resolve the issue of residual lightning voltage. A critical challenge remains due to the significant discrepancy between the high residual voltage levels following a lightning strike and the low voltage tolerance of many outdoor low-voltage electrical devices.

The problem is further exacerbated by the proliferation of the Internet of Things (IoT). An increasing number of smart electrical devices, such as sensors and control systems, are now installed outdoors to enable connectivity and automation. These devices are particularly vulnerable to lightning-induced overvoltage because of their sophisticated electronics and inherently low voltage withstand capabilities. Consequently, the frequency of lightning-induced damage to outdoor low-voltage smart electrical devices remains unacceptably high, presenting a pressing need for innovative solutions to enhance the resilience of these systems.

### SUMMARY

Technical advantages are generally achieved, by embodiments of this disclosure which describe a lightning-resistant power transmission system.

In accordance with one aspect of the present disclosure, a system comprises a first converter coupled to a first ac source, wherein the first converter is configured to convert a first ac voltage of the first ac source into a first ac current, a transmission line loop connected between two output terminals of the first converter, wherein the first ac current is configured to flow through the transmission line loop, and a second converter coupled to the transmission line loop, wherein the second converter is configured to convert the first ac current into a voltage fed into a load coupled to the second converter.

In accordance with another aspect of the present disclosure, a method comprises configuring a first converter to convert a first ac voltage into a first ac current flowing through a transmission line loop, and configuring a second converter to convert the first ac current into a voltage fed into a load coupled to the second converter.

In accordance with another aspect of the present disclosure, a lightning-resistant power transmission system comprises a first ac source coupled to a first substation, a first converter coupled to the first ac source, wherein the first converter is configured to convert a first ac voltage of the first ac source into a first ac current, a transmission line loop connected between two output terminals of the first converter, wherein the first ac current is configured to flow through the transmission line loop, and a second converter coupled to the transmission line loop, wherein the second converter is configured to convert the first ac current into a voltage, and a load coupled to the second converter and configured to receive the voltage.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a block diagram of a first implementation of a lightning-resistant power transmission system in accordance with various embodiments of the present disclosure;

FIG. 2 illustrates a schematic diagram of the first power converter shown in FIG. 1 in accordance with various embodiments of the present disclosure;

FIG. 3 illustrates a schematic diagram of a first implementation of the second power converter shown in FIG. 1 in accordance with various embodiments of the present disclosure;

FIG. 4 illustrates a schematic diagram of a second implementation of the second power converter shown in FIG. 1 in accordance with various embodiments of the present disclosure;

FIG. 5 illustrates a schematic diagram of a third implementation of the second power converter shown in FIG. 1 in accordance with various embodiments of the present disclosure;

FIG. 6 illustrates a block diagram of a second implementation of the lightning-resistant power transmission system in accordance with various embodiments of the present disclosure;

FIG. 7 illustrates a block diagram of a third implementation of the lightning-resistant power transmission system in accordance with various embodiments of the present disclosure;

FIG. 8 illustrates a block diagram of a fourth implementation of the lightning-resistant power transmission system in accordance with various embodiments of the present disclosure;

FIG. 9 illustrates a block diagram of a fifth implementation of the lightning-resistant power transmission system in accordance with various embodiments of the present disclosure;

FIG. 10 illustrates a schematic diagram of a first implementation of the second power converter shown in FIGS. 8-9 in accordance with various embodiments of the present disclosure;

FIG. 11 illustrates a schematic diagram of a second implementation of the second power converter shown in FIGS. 8-9 in accordance with various embodiments of the present disclosure; and

FIG. 12 illustrates a flow chart of a method for controlling the lightning-resistant power transmission system shown in FIG. 1 in accordance with various embodiments of the present disclosure;

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood to be within the scope of this disclosure. It is therefore intended that the appended claims encompass any such modifications or embodiments.

The present disclosure will be described with respect to embodiments in a specific context, namely a lightning-resistant power transmission system. The disclosure may also be applied, however, to a variety of power transmission systems. Hereinafter, various embodiments will be explained in detail with reference to the accompanying drawings.

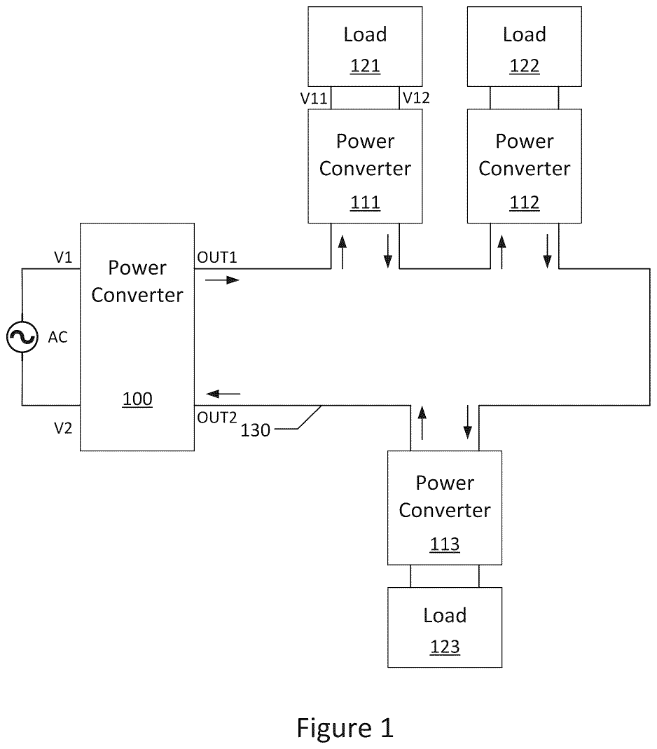

FIG. 1 illustrates a block diagram of a first implementation of a lightning-resistant power transmission system in accordance with various embodiments of the present disclosure. The lightning-resistant power transmission system comprises a first power converter 100, a plurality of second power converters 111, 112 and 113, and a transmission line loop 130. As shown in FIG. 1, the first power converter 100 is connected to an ac power source. A first output terminal V1 of the ac power source is connected to a first input of the first power converter 100. A second output terminal V2 of the ac power source is connected to a second input of the first power converter 100. A first output OUT1 of the first power converter 100 is connected to a first terminal of the transmission line loop 130. A second output OUT2 of the first power converter 100 is connected to a second terminal of the transmission line loop 130. The second power converter 111 is connected between the transmission line loop 130 and a first load 121. The second power converter 112 is connected between the transmission line loop 130 and a second load 122. The second power converter 113 is connected between the transmission line loop 130 and a third load 123.

It should be noted that FIG. 1 illustrates only three second powers converters and the associated loads of a lightning-resistant power transmission system that may include hundreds of such power converters and loads. The number of second power converters and loads illustrated herein is limited solely for the purpose of clearly illustrating the inventive aspects of the various embodiments. The present invention is not limited to any specific number of second power converters and loads.

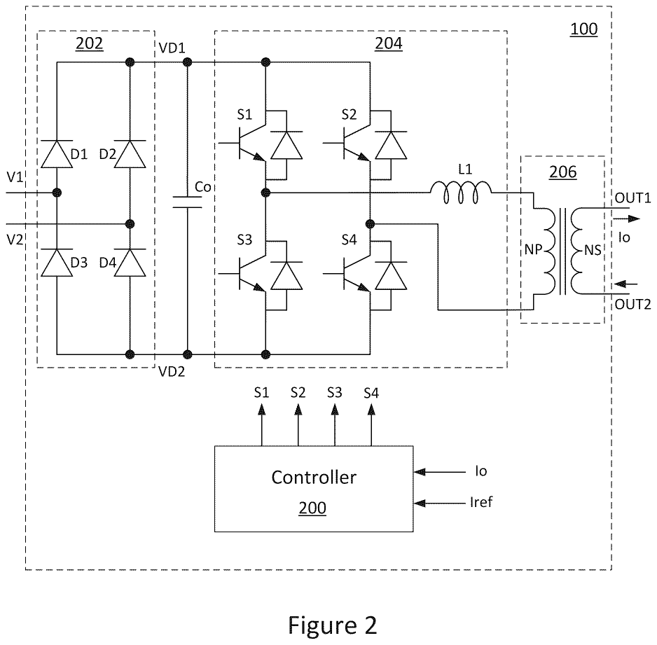

In some embodiments, the ac power source is from a power grid or a generator. The first power converter 100 is a voltage-to-current power converter. The first power converter 100 is configured to convert the ac voltage from the ac power source into a well-regulated ac current flowing through the transmission line loop 130. In operation, the first power converter 100 is configured to produce an ac sinusoidal wave current with a preset frequency and a preset amplitude. The frequency of the ac sinusoidal wave current is either a fundamental frequency or a medium frequency. The fundamental frequency is 50 Hz or 60 Hz, and the medium frequency ranges from 50 Hz to 500 Hz. Since a higher frequency ac current improves the efficiency of power conversion, but higher frequencies also increase line impedance, the ac current frequency is set to a medium frequency. This achieves a balance by enhancing power conversion efficiency while reducing line impedance. The detailed structure and operating principle of the first power converter 100 will be described below with respect to FIG. 2.

In some embodiments, the transmission line loop 130 is constructed using multi-stranded insulated wires. As is well known in the field, multi-stranded insulated wires reduce line impedance per unit length, minimize the skin effect, and provide larger conductor cross-sectional areas, thereby effectively reducing power losses.

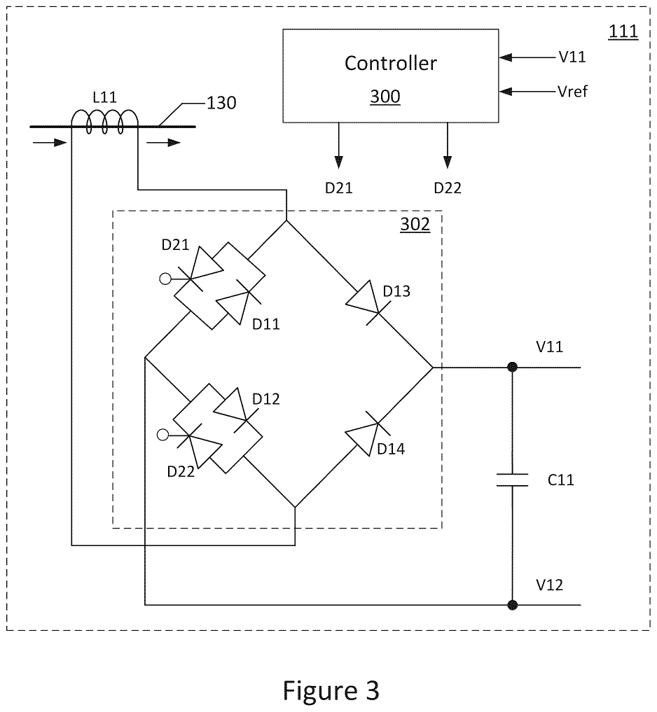

In some embodiments, the loads 121, 122 and 123 are low-voltage electrical equipment such as grid-dependent control circuits for renewable power generation systems. The second power converters 111, 112 and 113 are current-to-voltage power converters. The second power converter (e.g., second power converter 111) is configured to convert the ac current flowing through the transmission line loop 130 into a well-regulated ac voltage. Alternatively, the second power converter (e.g., second power converter 111) is configured to convert the ac current flowing through the transmission line loop 130 into a well-regulated dc voltage. The detailed structure and operating principle of the second power converter 111 will be described below with respect to FIGS. 3-5.

In some embodiments, the first power converter 100 is installed indoors, preventing direct lightning strikes. In alternative embodiments, the first power converter 100 is installed outdoors. When direct lightning strikes the housing of the first power converter 100, it does not affect the main circuit of the lightning-resistant power transmission system because the housing of the first power converter 100 is not part of the main circuit of the lightning-resistant power transmission system. This ensures the continuous and stable operation of the lightning-resistant power transmission system during lightning conditions without disrupting normal power supply. In some embodiments, the housing of the first power converter 100 is grounded. By adopting this configuration, the grounding of the housing of the first power converter 100 ensures that lightning current is directly discharged into the ground. The residual voltage on the housing of the first power converter 100 is extremely low, posing no threat to the safety of low-voltage electrical equipment or personnel.

In some embodiments, the transmission line loop 130 is grounded. By adopting this configuration, the grounding of the transmission line loop 130 ensures that lightning current is directly discharged into the ground. The impedance of the transmission line loop 130 is low, resulting in no high voltage or only minimal high voltage, thereby ensuring the safety of both the equipment and personnel in its vicinity.

In operation, when direct lightning strikes the housing of the second power converter 111, it does not affect the main circuit of the lightning-resistant power transmission system because the housing of the second power converter 111 is not part of the main circuit of the lightning-resistant power transmission system. This ensures the continuous and stable operation of the lightning-resistant power transmission system during lightning conditions without disrupting normal power supply. In some embodiments, the housing of the second power converter 111 is grounded. By adopting this configuration, the grounding of the housing of the second power converter 111 ensures that lightning current is directly discharged into the ground. The residual voltage on the housing of the second power converter 111 is extremely low, posing no threat to the safety of low-voltage electrical equipment or personnel.

By adopting the system configurations described above, when lightning directly strikes any position on the main circuit, a lightning voltage to ground is generated. If this voltage is excessively high and causes weak insulation points in the main circuit to break down, a ground discharge lightning current forms. However, due to the low impedance of the main circuit comprising the voltage-to-current power converter (e.g., the first power converter 100), the current transmission line loop 130 and the current-to-voltage power converters (e.g., the second power converter 111), any partial passage of lightning current through the main circuit does not generate an overvoltage, ensuring normal operation. Conversely, if the lightning voltage is insufficient to break down the weak insulation points, no lightning current is generated, and the circuit remains unaffected. This design reduces the risk of equipment damage from lightning strikes and ensures continuous and stable power supply during lightning conditions.

FIG. 2 illustrates a schematic diagram of the first power converter shown in FIG. 1 in accordance with various embodiments of the present disclosure. The first power converter 100 is a voltage-to-current power converter. As shown in FIG. 2, the first power converter 100 comprises a rectifier 202, a capacitor Co, an inverter 204 and a transformer 206 connected in cascade. The two inputs of the rectifier 202 are connected to two outputs V1 and V2 of the ac power source (shown in FIG. 1), respectively. The first power converter 100 is configured to produce a well-regulated current flowing from a first output terminal OUT1 of the first power converter 100 to a second output terminal OUT2 of the first power converter 100.

As shown in FIG. 2, the rectifier 202 comprises a first rectifier diode D1 and a third rectifier diode D3 connected between a first voltage bus VD1 and a second voltage bus VD2, and a second rectifier diode D2 and a fourth rectifier diode D4 connected between the first voltage bus VD1 and the second voltage bus VD2. The first output terminal V1 of the ac power source is connected to a common node of the first rectifier diode D1 and the third rectifier diode D3. The second output terminal V2 of the ac power source is connected to a common node of the second rectifier diode D2 and the fourth rectifier diode D4. The capacitor Co is connected between the first voltage bus VD1 and the second voltage bus VD2.

The inverter 204 comprises a first switch S1 and a third switch S3 connected between the first voltage bus VD1 and the second voltage bus VD2, a second switch S2 and a fourth switch S4 connected between the first voltage bus VD1 and the second voltage bus VD2, and an inductor L1 connected to a common node of the first switch S1 and the third switch S3. The transformer 206 comprises a primary winding NP and a secondary winding NS. A first terminal of the primary winding NP is connected to the inductor L1. A second terminal of the primary winding NP is connected to a common node of the second switch S2 and the fourth switch S4. The secondary winding NS is configured to generate the ac current Io flowing from the first output terminal OUT1 of the first power converter 100 to the second output terminal OUT2 of the first power converter 100. In some embodiments, a primary-to-secondary winding turns ratio of the transformer 206 is 3:1.

As shown in FIG. 2, the first power converter 100 further comprises a controller 200. As shown in FIG. 2, the controller 200 receives a signal representing the ac current Io and a predetermined reference current Iref. Based on the received signals, the controller 200 is configured to generate gate drive signals fed into the inverter 204. The gate drive signals are used for controlling the ac current Io.

In some embodiments, the controller 200 may be a system controller or a system control apparatus. The controller 200 may be implemented as a microprocessor, a digital signal processor and the like.

In operation, the rectifier 202 allows unidirectional current flow, effectively eliminating the negative portion of the ac waveform. The capacitor Co is configured to smooth the output to establish a steady dc voltage across the first voltage bus VD1 and the second voltage bus VD2. The controller 200 modulates the switches S1, S2, S3 and S4 to generate an ac current from the dc input using suitable techniques such as Pulse Width Modulation (PWM), sinusoidal PWM (SPWM) and the like. By alternating the conduction path of the switches, the inverter 204 reverses the polarity of the dc input, creating an ac waveform. By adjusting the switching frequency, duty cycle, or timing, the controller 200 ensures the output current is well-regulated in terms of amplitude, frequency, and waveform shape. Feedback from sensors at the output of the transformer 206 may be used for real-time adjustments. The inductor L1 is placed in series with the H-bridge formed by S1-S4 to smooth the current and limit sudden changes in current flow. The inductor L1 stores energy during each switching cycle and releases it to maintain a continuous current, minimizing ripple and improving the quality of the generated ac waveform. The ac waveform produced by the H-bridge is fed into the transformer 206, which steps up or steps down the signal level according to the requirements of the system. The transformer 206 also provides galvanic isolation between the input and output for safety and to protect downstream components.

In accordance with an embodiment, the switches (e.g., switches S1-S4) may be insulated gate bipolar transistor (IGBT) devices. Alternatively, the switches can be any controllable switches such as metal oxide semiconductor field-effect transistor (MOSFET) devices, integrated gate commutated thyristor (IGCT) devices, gate turn-off thyristor (GTO) devices, silicon-controlled rectifier (SCR) devices, junction gate field-effect transistor (JFET) devices, MOS controlled thyristor (MCT) devices, gallium nitride (GaN)-based power devices, silicon carbide (SiC)-based power devices and the like.

It should be noted while FIG. 2 shows the rectifier 202 is implemented as a diode rectifier, a person skilled in the art would recognize there may be many variations, modifications and alternatives. For example, depending on different applications and design needs, the diodes D1-D4 may be replaced by suitable switches.

FIG. 3 illustrates a schematic diagram of a first implementation of the second power converter shown in FIG. 1 in accordance with various embodiments of the present disclosure. The second converters 111, 112 and 113 shown in FIG. 1 are of a same structure. For simplicity, only the second converter 111 is described in detail below with respect to FIG. 3.

As shown in FIG. 3, the second converter 111 comprises an energy harvesting coil L11, a rectification circuit 302 and an output capacitor C11. The energy harvesting coil L11 is specifically designed to harvest energy from the electromagnetic fields of the transmission line loop 130. As shown in FIG. 3, the energy harvesting coil L11 is wound around a wire. The wire is part of the transmission line loop 130. As shown in FIG. 3, the ac current generated by the first power converter 100 shown in FIG. 2 flows through the wire.

The wire, a magnetic core (not shown) and the energy harvesting coil L11 form a transformer. In some embodiments, the energy harvesting coil L11 is directly placed around the wire. The energy harvesting coil L11 has N turns. This configuration forms a (1:N) transformation ratio. On the other hand, the wire can also be wound a few turns around the magnetic core. For example, if the wire is wound twice, the ratio becomes (2:N).

It should be noted that one turn of the wire shown in FIG. 3 is merely an example. The number of turns illustrated herein is limited solely for the purpose of clearly illustrating the inventive aspects of the various embodiments. The present invention is not limited to any specific number of turns.

The rectification circuit 302 comprises a first diode D11 and a second diode D12 connected in series between a first terminal and a second terminal of the energy harvesting coil L11, a third diode D13 and a fourth diode D14 connected in series between the first terminal and the second terminal of the energy harvesting coil L11, a first gate turn-off thyristor D21 connected in parallel with the first diode D11, and a second gate turn-off thyristor D22 connected in parallel with the second diode D12. The output capacitor C11 is connected between a common node of the third diode D13 and the fourth diode D14, and a common node of the first diode D11 and the second diode D12.

As shown in FIG. 3, an anode of the first diode D11 is connected to an anode of the second diode D12. An anode of the first gate turn-off thyristor D21 is connected to a cathode of the first diode D11. A cathode of the first gate turn-off thyristor D21 is connected to the anode of the first diode D11. An anode of the second gate turn-off thyristor D22 is connected to a cathode of the second diode D12. A cathode of the second gate turn-off thyristor D22 is connected to the anode of the second diode D12. A cathode of the third diode D13 is connected to a cathode of the fourth diode D14.

In some embodiments, the second power converter 111 is a controllable current-inducing power supply. A first output terminal of the second power converter 111 is denoted as V11. A second output terminal of the second power converter 111 is denoted as V12. The second power converter 111 is configured to convert the ac current flowing through the transmission line loop 130 into a dc voltage across V11 and V12.

In some embodiments, D11, D12, D13 and D14 form a bridge rectifier. D21 and D22 form a bypass circuit. In operation, the bypass circuit short-circuits the input current, while the bridge rectifier rectifies the input ac into dc, and outputs it to a filter circuit formed by C11. During a control cycle, the bypass circuit and the bridge rectifier operate alternately.

As shown in FIG. 3, the second power converter 111 further comprises a controller 300. As shown in FIG. 3, the controller 300 receives a signal representing the voltage on V11 and a predetermined reference voltage Vref. Based on the received signals, the controller 300 is configured to generate gate drive signals for D21 and D22. The gate drive signals are used for controlling the output voltage across V11 and V12. In particular, the controller 300 is configured to generate control signals to regulate the duty cycle, including the ON time ratio of the bypass circuit and the bridge rectifier.

In operation, in a first implementation, the controller 300 uses a PWM control scheme, generating a PWM control signal with an adjustable duty cycle. Based on the high and low levels of the PWM control signal, the bypass circuit and/or the bridge rectifier switches between conduction and shutoff. The controller 300 maintains the stability of the current-inducing power supply output by adjusting the duty cycle of the PWM control signal.

In operation, in a second implementation, the controller 300 may employ an SPWM control scheme, generating an SPWM control signal with an adjustable modulation ratio. The bypass circuit and/or the bridge rectifier responds to the high and low levels of the SPWM control signal, switching between conduction and shutoff. The controller 300 maintains the stability of the current-inducing power supply output by adjusting the modulation ratio of the SPWM control signal.

In operation, in a third implementation, the controller 300 may adopt a phase control scheme, regulating the ON time ratio of the bypass circuit and the bridge rectifier by adjusting the initial phase control value of D21 and D22.

In some embodiments, the first implementation (PWM control), the second implementation (SPWM control) and the third implementation (phase control) are applied to the rectification circuit in an alternating manner.

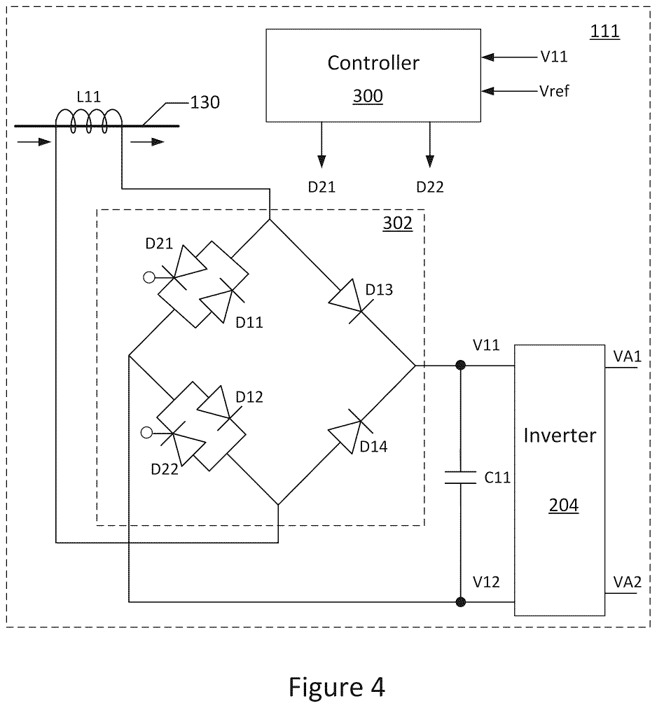

FIG. 4 illustrates a schematic diagram of a second implementation of the second power converter shown in FIG. 1 in accordance with various embodiments of the present disclosure. The second implementation of the second power converter shown in FIG. 4 is similar to the first implementation of the second power converter shown in FIG. 3 except that an inverter 204 is employed to convert the dc voltage across V11 and V12 into an ac voltage across VA1 and VA2. In some embodiments, the load requires ac power for its operation. The load is connected to the output of the inverter 204. In alternative embodiments, the load requires both ac and dc power for its operation. For example, motors may use ac power for operation. Control circuits and sensors require dc power. Under this system requirement, the loads requiring ac power are connected to the output of the inverter 204. The loads requiring dc power are connected to the output of the rectification circuit 302.

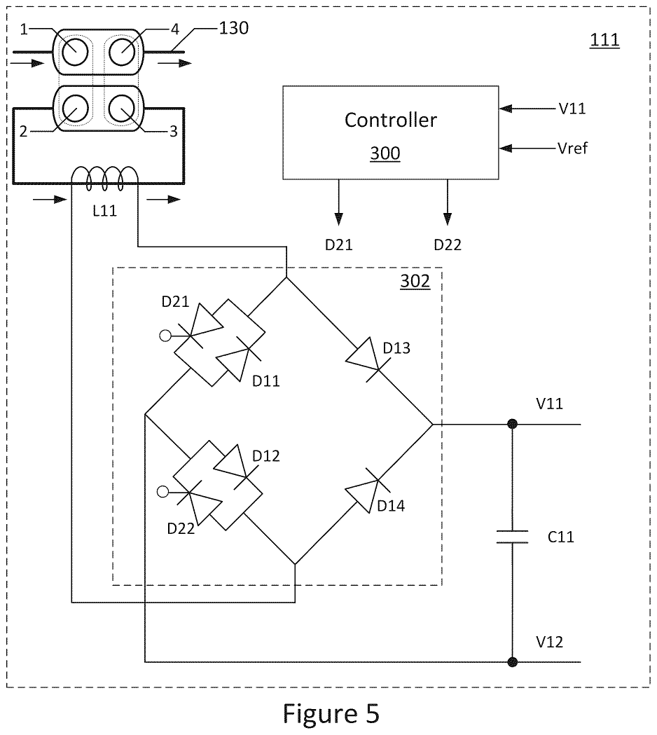

FIG. 5 illustrates a schematic diagram of a third implementation of the second power converter shown in FIG. 1 in accordance with various embodiments of the present disclosure. The third implementation of the second power converter shown in FIG. 5 is similar to the first implementation of the second power converter shown in FIG. 3 except that an anti-disconnection switch is employed to connect or disconnect low-voltage electrical equipment seamlessly without causing any interruption.

As shown in FIG. 5, the anti-disconnection switch comprising a first terminal 1, a second terminal 2, a third terminal 3 and a fourth terminal 4. The first terminal 1 is connected to a first node of the transmission line loop 130. The fourth terminal 4 is connected to a second node of the transmission line loop 130. The first node and the second node of the transmission line loop 130 are configured to be connected to each other through the anti-disconnection switch. The second terminal 2 is connected to a first terminal of the wire around which the energy harvesting coil L11 is wound. The third terminal 3 is connected to a second terminal of the wire.

In operation, when the first terminal 1 is connected to the second terminal 2, and the third terminal 3 is connected to the fourth terminal 4, the second power converter 111 is connected to the transmission line loop 130. The second power converter 111 is configured to output a dc voltage and/or an ac voltage.

In operation, when it is necessary to add low-voltage electrical equipment into the transmission line loop 130 or remove the low-voltage electrical equipment from the transmission line loop 130, the first terminal 1 and fourth terminal 4 of the anti-disconnection switch are connected, and the connection between the first terminal 1 and the second terminal 2, as well as the connection between the third terminal 3 and the fourth terminal 4, are both disconnected. In this case, the ac current flows through the transmission line loop 130 from the first terminal 1 to the fourth terminal 4 without entering the wire around which the energy harvesting coil L11 is wound. The low-voltage electrical equipment can be added or removed. This ensures the normal transmission of current on the transmission line loop 130 without causing any interruption during the installation and removal processes of the low-voltage electrical equipment.

After completing the operation of adding or removing low-voltage electrical equipment, the first terminal 1 and the second terminal 2 of the anti-disconnection switch are connected, and the third terminal 3 and the fourth terminal 4 are connected. Then, the connection between the first terminal 1 and fourth terminal 4 is disconnected. At this point, the ac current flows through the transmission line loop 130, the first terminal 1, and the second terminal 2 into the second power converter 111 for supplying power.

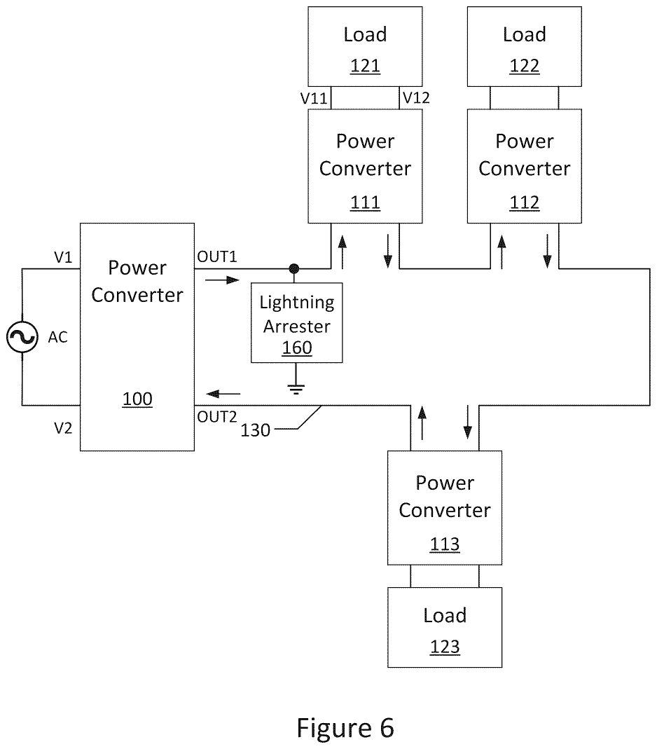

FIG. 6 illustrates a block diagram of a second implementation of the lightning-resistant power transmission system in accordance with various embodiments of the present disclosure. The second implementation of the lightning-resistant power transmission system shown in FIG. 6 is similar to the first implementation of the lightning-resistant power transmission system shown in FIG. 1 except that a lightning arrester 160 is connected between the transmission line loop 130 and ground. The indirect grounding shown in FIG. 6 is achieved through voltage-sensitive devices. The voltage-sensitive devices include varistors, overvoltage protectors, and discharge switches.

In operation, when direct lightning strikes any position on the transmission line loop 130, the lightning current will pass through the transmission line loop 130 and be discharged directly or indirectly into the ground via voltage-sensitive devices. Due to the low impedance of the transmission line loop 130, no high voltage or only minimal high voltage is generated, ensuring the safety of equipment and personnel in the vicinity.

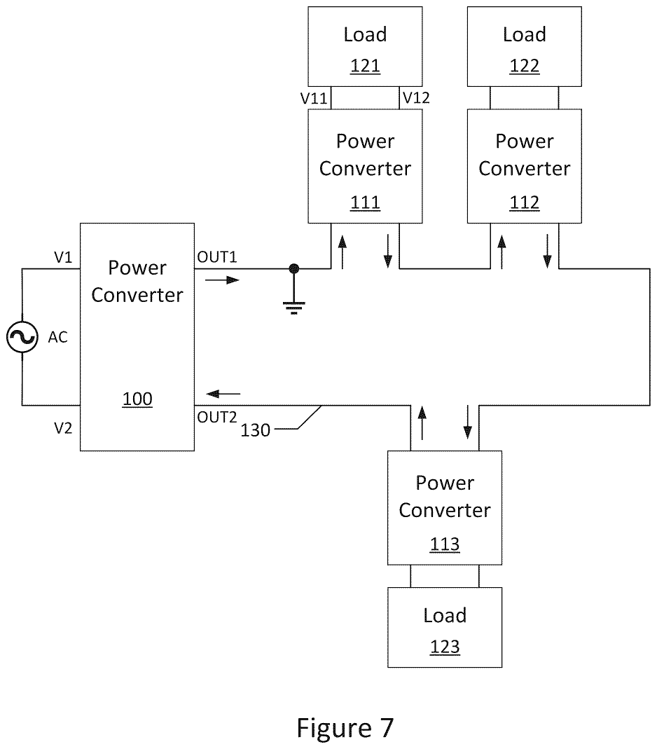

FIG. 7 illustrates a block diagram of a third implementation of the lightning-resistant power transmission system in accordance with various embodiments of the present disclosure. The third implementation of the lightning-resistant power transmission system shown in FIG. 7 is similar to the first implementation of the lightning-resistant power transmission system shown in FIG. 1 except that the transmission line loop 130 is directly connected to ground as shown in FIG. 7.

In operation, when direct lightning strikes any position on the transmission line loop 130, the lightning current will pass through the transmission line loop 130 and be discharged directly into the ground. The grounding of the transmission line loop 130 ensures that lightning current is directly discharged into the ground. The impedance of the transmission line loop 130 is low, resulting in no high voltage or only minimal high voltage, thereby ensuring the safety of both the equipment and personnel in its vicinity.

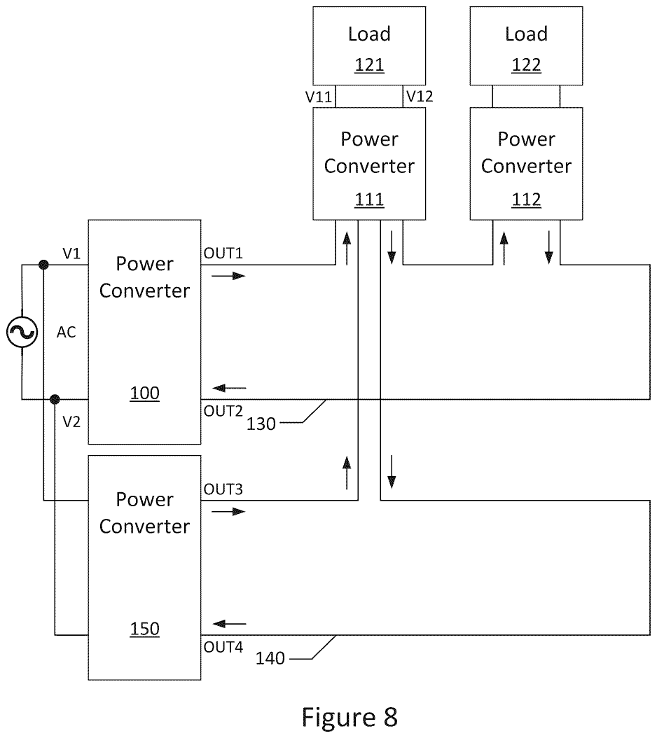

FIG. 8 illustrates a block diagram of a fourth implementation of the lightning-resistant power transmission system in accordance with various embodiments of the present disclosure. The fourth implementation of the lightning-resistant power transmission system shown in FIG. 8 is similar to the first implementation of the lightning-resistant power transmission system shown in FIG. 1 except that a third power converter 150 and the associated transmission line loop 140 are employed to improve system reliability and ensure uninterrupted power delivery. In some embodiments, the third power converter 150 and the first power converter 100 share a same structure, and hence the structure and operating principle of the third power converter 150 are not discussed herein to avoid repetition.

As shown in FIG. 8, the third power converter 150 is coupled to the ac source. The third power converter 150 is configured to convert the ac voltage of the ac source into a second ac current flowing through the transmission line loop 140. The second ac current flows from the output terminal OUT3 and flows into the output terminal OUT4. Both the transmission line loop 130 and the transmission line loop 140 are electrically coupled to the second power converter 111. The second power converter 111 is configured to convert at least one of the ac currents into the voltage fed into the load 121.

In some embodiments, the load 121 is a critical load requiring a reliable power supply to avoid power outages. The system shown in FIG. 8 functions as a dual-fed or dual-source power system. If one power converter (e.g., power converter 100) encounters a fault (e.g., equipment failure or maintenance), the other power converter (e.g., power converter 150) can seamlessly continue to supply power, preventing downtime.

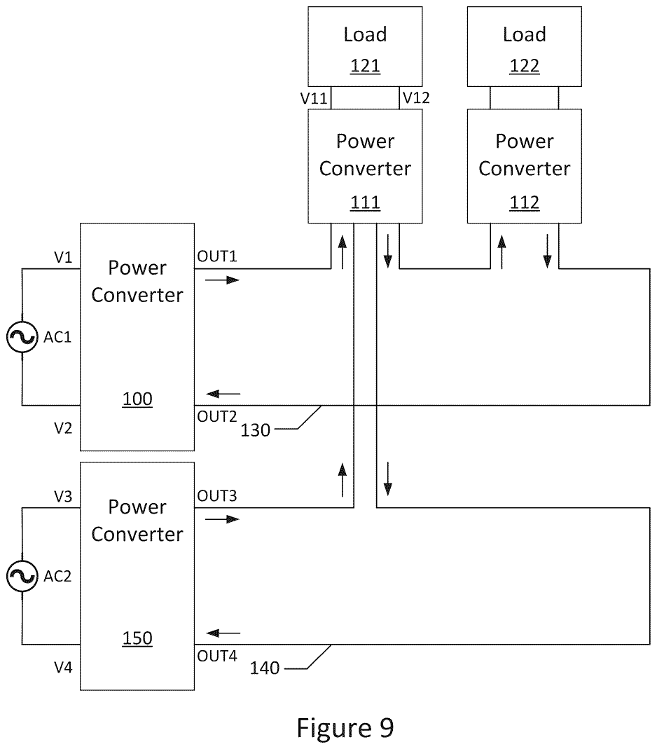

FIG. 9 illustrates a block diagram of a fifth implementation of the lightning-resistant power transmission system in accordance with various embodiments of the present disclosure. The fifth implementation of the lightning-resistant power transmission system shown in FIG. 9 is similar to the fourth implementation of the lightning-resistant power transmission system shown in FIG. 8 except that the third power converter 150 is connected to a second ac source independent from the first ac source.

As shown in FIG. 9, the first power converter 100 is coupled to a first ac source AC1. The first power converter 100 is configured to convert the ac voltage of the first ac source into a first ac current flowing through the transmission line loop 130. The third power converter 150 is coupled to a second ac source AC2. The third power converter 150 is configured to convert the ac voltage of the second ac source into a second ac current flowing through the transmission line loop 140. The second power converter 111 is configured to convert at least one of the ac currents into the voltage fed into the load 121.

In some embodiments, the second ac source AC2 is coupled to a second substation. The first ac source AC1 is coupled to a first substation. These two substations are connected to independent power generation sources or transmission lines. In other words, the second substation is independent from the first substation. Supplying power from two independent substations helps to improve system reliability and ensure uninterrupted power delivery.

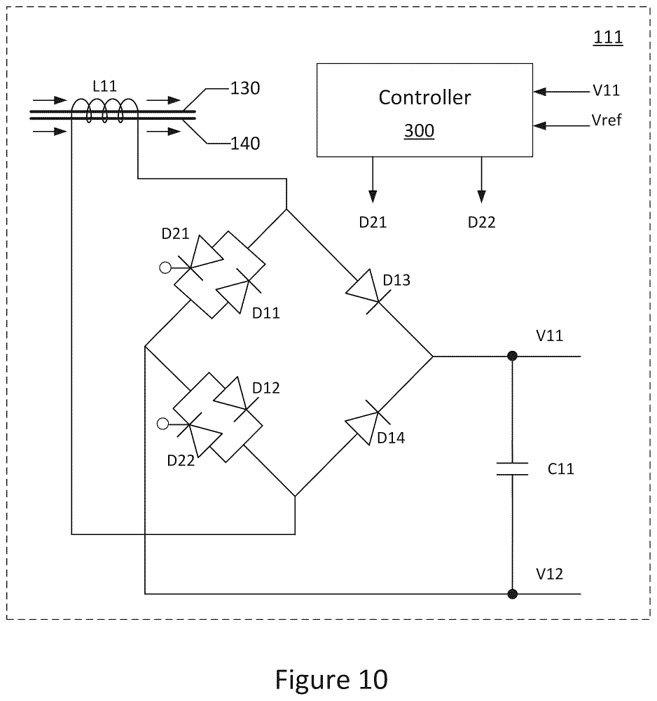

FIG. 10 illustrates a schematic diagram of a first implementation of the second power converter shown in FIGS. 8-9 in accordance with various embodiments of the present disclosure. The implementation of the second power converter shown in FIG. 10 is similar to that shown in FIG. 3 except that the energy harvesting coil L11 is wound around two wires. One wire is part of the transmission line loop 130. The other wire is part of the transmission line loop 140. The second power converter 111 is configured to convert at least one of the ac currents into the dc voltage across V11 and V12.

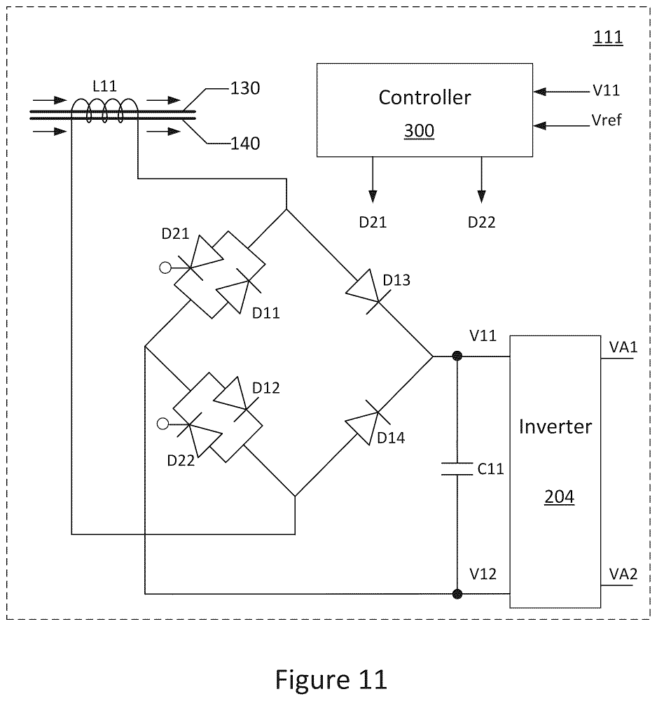

FIG. 11 illustrates a schematic diagram of a second implementation of the second power converter shown in FIGS. 8-9 in accordance with various embodiments of the present disclosure. The implementation of the second power converter shown in FIG. 11 is similar to that shown in FIG. 4 except that the energy harvesting coil L11 is wound around two wires. One wire is part of the transmission line loop 130. The other wire is part of the transmission line loop 140. The second power converter 111 is configured to convert at least one of the ac currents into the dc voltage across V11 and V12, and the ac voltage across VA1 and VA2.

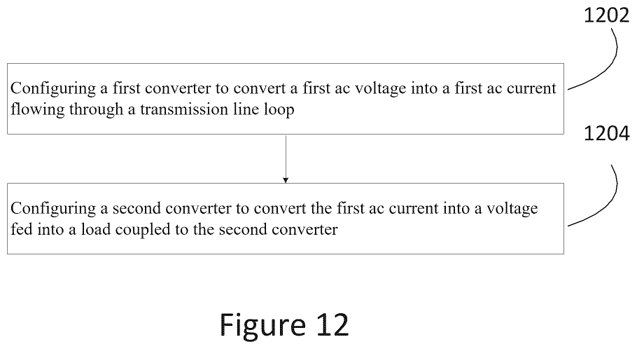

FIG. 12 illustrates a flow chart of a method for controlling the lightning-resistant power transmission system shown in FIG. 1 in accordance with various embodiments of the present disclosure. This flowchart shown in FIG. 12 is merely an example, which should not unduly limit the scope of the claims. One of ordinary skill in the art would recognize many variations, alternatives, and modifications. For example, various steps illustrated in FIG. 12 may be added, removed, replaced, rearranged and repeated.

At step 1202, a first converter is configured to convert a first ac voltage into a first ac current flowing through a transmission line loop.

At step 1204, a second converter is configured to convert the first ac current into a voltage fed into a load coupled to the second converter.

In some embodiments, the first converter comprises a rectifier, a capacitor, an inverter and a transformer connected in cascade, and wherein: the rectifier comprises a first rectifier diode and a third rectifier diode connected between a first voltage bus and a second voltage bus, and a third rectifier diode and a fourth rectifier diode connected between the first voltage bus and the second voltage bus, and wherein a first output terminal of the first ac source is connected to a common node of the first rectifier diode and the third rectifier diode, and a second output terminal of the first ac source is connected to a common node of the second rectifier diode and the fourth rectifier diode, the capacitor is connected between the first voltage bus and the second voltage bus, the inverter comprises a first switch and a third switch connected between the first voltage bus and the second voltage bus, a third switch and a fourth switch connected between the first voltage bus and the second voltage bus, and an inductor connected to a common node of the first switch and the third switch, and the transformer comprises a primary winding and a secondary winding, and wherein: a first terminal of the primary winding is connected to the inductor; a second terminal of the primary winding is connected to a common node of the second switch and the fourth switch; and the secondary winding is configured to generate the first ac current; and the second converter comprises an energy harvesting coil, a rectification circuit and an output capacitor, and wherein: the energy harvesting coil is wound around a wire through which the first ac current flows, the rectification circuit comprises a first diode and a second diode connected in series between a first terminal of the energy harvesting coil and a second terminal of the energy harvesting coil, a third diode and a fourth diode connected in series between the first terminal of the energy harvesting coil and the second terminal of the energy harvesting coil, a first gate turn-off thyristor connected in parallel with the first diode, and a second gate turn-off thyristor connected in parallel with the second diode, and the output capacitor is connected between a common node of the third diode and the fourth diode, and a common node of the first diode and the second diode.

The method further comprises configuring a third converter to convert the first ac voltage into a second ac current, and configuring the second converter to convert at least one of the first ac current and the second ac current into the voltage fed into the load coupled to the second converter.

The method further comprises configuring a third converter to convert a second ac voltage into a second ac current, and configuring the second converter to convert at least one of the first ac current and the second ac current into the voltage fed into the load coupled to the second converter.

In some embodiments, the first ac voltage is from a first substation, and the second ac voltage is from a second substation, and wherein the first substation is independent from the second substation.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, which may perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, or steps.

What is claimed is:

1. A system comprising:
a first converter coupled to a first ac source, wherein the first converter is configured to convert a first ac voltage of the first ac source into a first ac current;
a transmission line loop connected between two output terminals of the first converter, wherein the first ac current is configured to flow through the transmission line loop; and
a second converter coupled to the transmission line loop, wherein the second converter is configured to convert the first ac current into a voltage fed into a load coupled to the second converter.

2. The system of claim 1, wherein:
the first converter is a voltage-to-current power converter comprising a rectifier, a capacitor, an inverter and a transformer connected in cascade.

3. The system of claim 1, wherein:
the rectifier comprises a first rectifier diode and a third rectifier diode connected between a first voltage bus and a second voltage bus, and a second rectifier diode and a fourth rectifier diode connected between the first voltage bus and the second voltage bus, and wherein a first output terminal of the first ac source is connected to a common node of the first rectifier diode and the third rectifier diode, and a second output terminal of the first ac source is connected to a common node of the second rectifier diode and the fourth rectifier diode;
the capacitor is connected between the first voltage bus and the second voltage bus;
the inverter comprises a first switch and a third switch connected between the first voltage bus and the second voltage bus, a second switch and a fourth switch connected between the first voltage bus and the second voltage bus, and an inductor connected to a common node of the first switch and the third switch; and
the transformer comprises a primary winding and a secondary winding, and wherein:
a first terminal of the primary winding is connected to the inductor;
a second terminal of the primary winding is connected to a common node of the second switch and the fourth switch; and
the secondary winding is configured to generate the first ac current.

4. The system of claim 3, wherein:
a primary-to-secondary winding turns ratio of the transformer is 3:1.

5. The system of claim 1, wherein:
the transmission line loop is formed by a multi-strand insulated wire with small skin effect.

6. The system of claim 1, wherein:
the second converter comprises an energy harvesting coil, a rectification circuit and an output capacitor, and wherein:
the energy harvesting coil is wound around a wire through which the first ac current flows;
the rectification circuit comprises a first diode and a second diode connected in series between a first terminal of the energy harvesting coil and a second terminal of the energy harvesting coil, a third diode and a fourth diode connected in series between the first terminal of the energy harvesting coil and the second terminal of the energy harvesting coil, a first gate turn-off thyristor connected in parallel with the first diode, and a second gate turn-off thyristor connected in parallel with the second diode; and
the output capacitor is connected between a common node of the third diode and the fourth diode, and a common node of the first diode and the second diode.

7. The system of claim 6, wherein:
an anode of the first diode is connected to an anode of the second diode;
an anode of the first gate turn-off thyristor is connected to a cathode of the first diode;
a cathode of the first gate turn-off thyristor is connected to the anode of the first diode;
an anode of the second gate turn-off thyristor is connected to a cathode of the second diode;
a cathode of the second gate turn-off thyristor is connected to the anode of the second diode; and
a cathode of the third diode is connected to a cathode of the fourth diode.

8. The system of claim 6, further comprising:
an anti-disconnection switch comprising a first terminal, a second terminal, a third terminal and a fourth terminal, wherein:
the first terminal is connected to a first node of the transmission line loop;
the fourth terminal is connected to a second node of the transmission line loop, wherein the first node and the second node of the transmission line loop are configured to be connected to each other through the anti-disconnection switch;
the second terminal is connected to a first terminal of the wire; and
the third terminal is connected to a second terminal of the wire.

9. The system of claim 1, further comprising:
a lightning arrester connected between the transmission line loop and ground.

10. The system of claim 1, wherein:
the transmission line loop is directly connected to ground.

11. The system of claim 1, further comprising:
a third converter coupled to the first ac source, wherein the third converter is configured to convert the first ac voltage of the first ac source into a second ac current, wherein:
the second converter is configured to convert at least one of the first ac current and the second ac current into the voltage fed into the load coupled to the second converter.

12. The system of claim 1, further comprising:
a second ac source independent from the first ac source; and
a third converter coupled to the second ac source, wherein the third converter is configured to convert a second ac voltage of the second ac source into a second ac current, wherein:
the second converter is configured to convert at least one of the first ac current and the second ac current into the voltage fed into the load coupled to the second converter.

13. A method comprising:
configuring a first converter to convert a first ac voltage into a first ac current flowing through a transmission line loop; and
configuring a second converter to convert the first ac current into a voltage fed into a load coupled to the second converter.

14. The method of claim 13, wherein:
the first converter comprises a rectifier, a capacitor, an inverter and a transformer connected in cascade, and wherein:
the rectifier comprises a first rectifier diode and a third rectifier diode connected between a first voltage bus and a second voltage bus, and a second rectifier diode and a fourth rectifier diode connected between the first voltage bus and the second voltage bus, and wherein a first output terminal of the first ac source is connected to a common node of the first rectifier diode and the third rectifier diode, and a second output terminal of the first ac source is connected to a common node of the second rectifier diode and the fourth rectifier diode;
the capacitor is connected between the first voltage bus and the second voltage bus;
the inverter comprises a first switch and a third switch connected between the first voltage bus and the second voltage bus, a second switch and a fourth switch connected between the first voltage bus and the second voltage bus, and an inductor connected to a common node of the first switch and the third switch; and
the transformer comprises a primary winding and a secondary winding, and wherein:
a first terminal of the primary winding is connected to the inductor;
a second terminal of the primary winding is connected to a common node of the second switch and the fourth switch; and
the secondary winding is configured to generate the first ac current; and
the second converter comprises an energy harvesting coil, a rectification circuit and an output capacitor, and wherein:
the energy harvesting coil is wound around a wire through which the first ac current flows;
the rectification circuit comprises a first diode and a second diode connected in series between a first terminal of the energy harvesting coil and a second terminal of the energy harvesting coil, a third diode and a fourth diode connected in series between the first terminal of the energy harvesting coil and the second terminal of the energy harvesting coil, a first gate turn-off thyristor connected in parallel with the first diode, and a second gate turn-off thyristor connected in parallel with the second diode; and
the output capacitor is connected between a common node of the third diode and the fourth diode, and a common node of the first diode and the second diode.

15. The method of claim 13, further comprising:
configuring a third converter to convert the first ac voltage into a second ac current; and
configuring the second converter to convert at least one of the first ac current and the second ac current into the voltage fed into the load coupled to the second converter.

16. The method of claim 13, further comprising:
configuring a third converter to convert a second ac voltage into a second ac current; and
configuring the second converter to convert at least one of the first ac current and the second ac current into the voltage fed into the load coupled to the second converter.

17. The method of claim 16, wherein:
the first ac voltage is from a first substation; and
the second ac voltage is from a second substation, and wherein the first substation is independent from the second substation.

18. A lightning-resistant power transmission system comprising:
a first ac source coupled to a first substation;
a first converter coupled to the first ac source, wherein the first converter is configured to convert a first ac voltage of the first ac source into a first ac current;
a transmission line loop connected between two output terminals of the first converter, wherein the first ac current is configured to flow through the transmission line loop; and
a second converter coupled to the transmission line loop, wherein the second converter is configured to convert the first ac current into a voltage; and
a load coupled to the second converter and configured to receive the voltage.

19. The lightning-resistant power transmission system of claim 18, wherein:
the first converter comprises a rectifier, a capacitor, an inverter and a transformer connected in cascade, and wherein:
the rectifier comprises a first rectifier diode and a third rectifier diode connected between a first voltage bus and a second voltage bus, and a second rectifier diode and a fourth rectifier diode connected between the first voltage bus and the second voltage bus, and wherein a first output terminal of the first ac source is connected to a common node of the first rectifier diode and the third rectifier diode, and a second output terminal of the first ac source is connected to a common node of the second rectifier diode and the fourth rectifier diode;
the capacitor is connected between the first voltage bus and the second voltage bus;
the inverter comprises a first switch and a third switch connected between the first voltage bus and the second voltage bus, a second switch and a fourth switch connected between the first voltage bus and the second voltage bus, and an inductor connected to a common node of the first switch and the third switch; and
the transformer comprises a primary winding and a secondary winding, and wherein:
a first terminal of the primary winding is connected to the inductor;
a second terminal of the primary winding is connected to a common node of the second switch and the fourth switch; and
the secondary winding is configured to generate the first ac current;
the transmission line loop is formed by a multi-strand insulated wire with small skin effect; and
the second converter comprises an energy harvesting coil, a rectification circuit and an output capacitor, and wherein:
the energy harvesting coil is wound around a wire through which the first ac current flows;
the rectification circuit comprises a first diode and a second diode connected in series between a first terminal of the energy harvesting coil and a second terminal of the energy harvesting coil, a third diode and a fourth diode connected in series between the first terminal of the energy harvesting coil and the second terminal of the energy harvesting coil, a first gate turn-off thyristor connected in parallel with the first diode, and a second gate turn-off thyristor connected in parallel with the second diode; and
the output capacitor is connected between a common node of the third diode and the fourth diode, and a common node of the first diode and the second diode.

20. The lightning-resistant power transmission system of claim 19, further comprising:
a second ac source coupled to a second substation, wherein the second substation is independent from the first substation; and
a third converter coupled to the second ac source, wherein the third converter is configured to convert a second ac voltage of the second ac source into a second ac current, wherein
the second converter is configured to convert at least one of the first ac current and the second ac current into the voltage fed into the load coupled to the second converter.
